(19) United States
(12) Patent Application Publication
(10) Pub. No.: US 2026/0012930 A1
(43) Pub. Date: Jan. 8, 2026

(54) COMMUNICATION CONTROL METHOD

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/323,603

(22) Filed: Sep. 9, 2025

Related U.S. Application Data
(63) Continuation of application No. PCT/JP2024/008524, filed on Mar. 6, 2024.

(30) Foreign Application Priority Data
Mar. 10, 2023 (JP) 2023-037652

(51) Int. Cl. H04W 72/02; H04L 43/0811; H04W 28/26; H04W 88/08

(52) U.S. Cl. CPC H04W 72/02; H04L 43/0811; H04W 28/26; H04W 88/08

(57) ABSTRACT

A communication control method according to the disclosure is a communication control method in a wireless communication system. The communication control method includes requesting, by a communication node, a base station to perform backscattering (BS) reception of a signal reflected from a wireless tag. The request includes information indicating at least one selected from the group consisting of a radio resource used for the BS reception, a cell ID indicating a cell operated by the base station that performs the BS reception, and identifier information indicating an identifier identifying the wireless tag.

### RELATED APPLICATIONS

The present application is a continuation based on PCT Application No. PCT/JP2024/008524, filed on Mar. 6, 2024, which claims the benefit of Japanese Patent Application No. 2023-037652 filed on Mar. 10, 2023. The content of which is incorporated by reference herein in their entirety.

### TECHNICAL FIELD

The present disclosure relates to a communication control method in wireless communication systems.

### BACKGROUND

In the Third Generation Partnership Project (3GPP) (trade name, the same applies hereinafter) that is a standardization project for mobile communication systems, discussion is being made on ambient power-enabled Internet of Things (ambient IoT) (for example, see Non-Patent Document 1 to Non-Patent Document 6).

Ambient IoT is a technology that supports, for example, ultra-low cost and ultra-low power devices.

### CITATION LIST

### Non-Patent Literature

Non-Patent Document 1: 3GPP Contribution RP-222733

### Non-Patent Document 2: 3GPP Contribution RP-222985

### Non-Patent Document 3: 3GPP Contribution RP-223033

### Non-Patent Document 4: 3GPP Contribution RP-223034

### Non-Patent Document 5: 3GPP Contribution RP-223526

### SUMMARY

A communication control method according to a first aspect is a communication control method in a wireless communication system, the communication control method including: requesting, by a communication node, a network node to perform backscattering (BS) reception of a signal reflected from a wireless tag, in which the request includes information indicating at least one selected from the group consisting of a radio resource used for the BS reception, a cell ID indicating a cell operated by the network node that performs the BS reception, and identifier information indicating an identifier identifying the wireless tag.

### BRIEF DESCRIPTION OF THE DRAWINGS

FIG. 1 is a diagram illustrating a configuration example of a wireless communication system according to a first embodiment.

FIG. 2 is a diagram illustrating a configuration example of a User Equipment (UE) according to the first embodiment.

FIG. 3 is a diagram illustrating a configuration example of a gNB (base station) according to the first embodiment.

FIG. 4 is a diagram illustrating a configuration example of a wireless tag according to the first embodiment.

FIG. 5 is a diagram illustrating a configuration example of a protocol stack for a user plane according to the first embodiment.

FIG. 6 is a diagram illustrating a configuration example of a protocol stack for a control plane according to the first embodiment.

FIG. 7 is a diagram illustrating a link configuration example of a first topology (topology (1)) according to the first embodiment.

FIG. 8 is a diagram illustrating a link configuration example of a second topology (topology (2)) according to the first embodiment.

FIG. 9 is a diagram illustrating a link configuration example of a third topology (topology (3)) according to the first embodiment.

FIG. 10 is a diagram illustrating a link configuration example of a fourth topology (topology (4)) according to the first embodiment.

FIG. 11 is a diagram illustrating a link configuration example of a fifth topology (topology (5)) according to the first embodiment.

FIG. 12 is a diagram illustrating a first operation example according to the first embodiment.

FIG. 13 is a diagram illustrating a configuration example of a gNB according to a second embodiment.

FIG. 14 is a diagram illustrating an operation example according to the second embodiment.

FIG. 15 is a diagram illustrating an operation example according to a third embodiment.

FIG. 16 is a diagram illustrating an operation example according to a fourth embodiment.

### DESCRIPTION OF EMBODIMENTS

The present disclosure provides appropriate communication with a wireless tag in a wireless communication system.

A wireless communication system according to an embodiment is described with reference to the drawings. In the description of the drawings, the same or similar parts are denoted by the same or similar reference signs.

### First Embodiment

### Configuration Example of Wireless Communication System

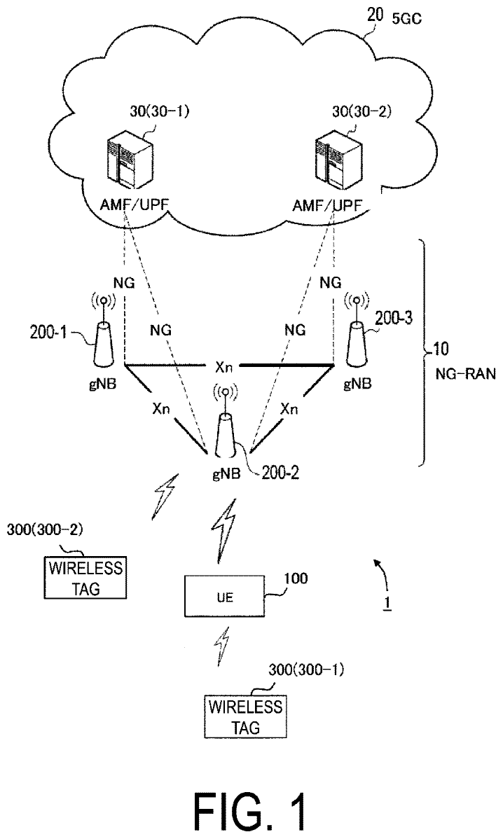

FIG. 1 is a diagram illustrating a configuration example of a wireless communication system according to a first embodiment. A wireless communication system 1 includes a mobile communication system that is the 5th Generation System (5GS) of the 3GPP standard. The description below takes the 5GS as an example of the mobile communication system, but a Long Term Evolution (LTE) system may at least partially be applied. As the mobile communication system, a sixth generation (6G) system or a subsequent system may at least partially be applied. Note that the wireless communication system 1 may be the mobile communication system.

The wireless communication system 1 includes a User Equipment (UE) 100, a 5G Next Generation Radio Access Network (NG-RAN) 10, a 5G Core Network (5GC) 20, and a wireless tag 300. The 5GC 20 may be hereinafter simply referred to as a core network (CN) 20.

The UE 100 is a mobile wireless communication apparatus. The UE 100 may be any apparatus as long as it is used by a user. Examples of the UE 100 include a mobile phone terminal (including a smartphone) or a tablet terminal, a notebook PC, a communication module (including a communication card or a chipset), a sensor or an apparatus provided to a sensor, a vehicle or an apparatus provided to a vehicle (Vehicle UE), and a flying object or an apparatus provided to a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. Note that a “cell” is used as a term indicating a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) 30 and a User Plane Function (UPF). The AMF 30 performs various types of mobility control and the like for the UE 100. The AMF 30 manages mobility of the UE 100 by communicating with the UE 100 by using Non-Access Stratum (NAS) signaling. The UPF controls data transfer. The

AMF 30 and the UPF are connected to the gNB 200 via an NG interface, which is an interface between the base station and the core network.

The wireless tag 300 is a wireless communication apparatus capable of wireless communication with the UE 100 or the gNB 200. The wireless tag 300 is also an information medium including a built-in memory to and from which data or the like is written or read using radio waves or electromagnetic fields. The wireless tag 300 is, for example, an Internet of Things (IoT) device that is extremely small, thin, lightweight, and with low complexity.

Note that, in the first embodiment, the wireless tag 300 is an information medium that

writes data or the like to or reads data or the like from a built-in memory by using a radio wave method.

Examples are illustrated in which communication destinations communicating with the wireless tag 300 are the gNB 200 and the UE 100, but in the first embodiment, a transmission source of a signal transmitted to the wireless tag 300 and a reception destination of a reflected wave of the signal transmitted to the wireless tag 300 may be different from each other. For example, there is a case that the UE 100 transmits a signal to the wireless tag 300 as the transmission source of a signal, and the gNB 200 is the reception destination of the reflected wave of the signal transmitted to the wireless tag 300. Further, for example, there is a case that the gNB 200 transmits a signal to the wireless tag 300 as the transmission source of the signal, and the UE 100 is the reception destination of the reflected wave of the signal transmitted to the wireless tag 300. Furthermore, for example, a transmission wave that the wireless tag 300 transmits may function with a signal transmitted to the wireless tag 300 as a power source (or as a trigger).

### Configuration Example of UE

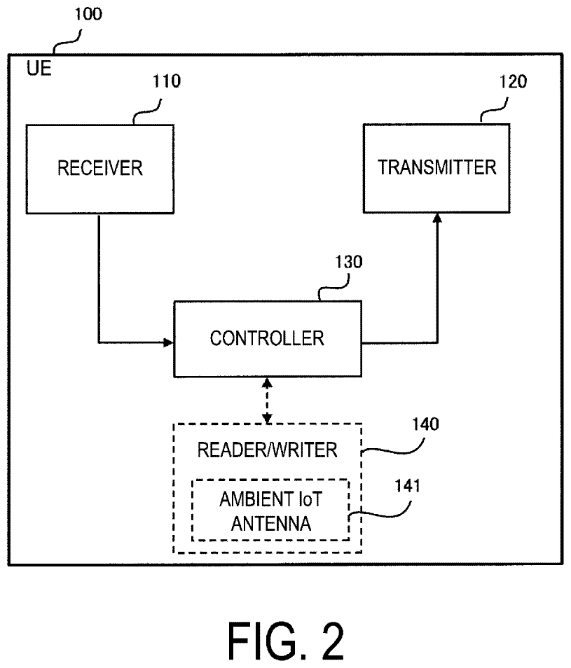

FIG. 2 is a diagram illustrating a configuration example of the user equipment 100 (UE) according to the first embodiment. The UE 100 includes a receiver 110, a transmitter 120, and a controller 130. The UE 100 may include a reader/writer 140. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. In the example described below, operations or processing in the UE 100 may be performed by the controller 130.

The reader/writer 140 includes an ambient IoT antenna 141. The reader/writer 140 communicates with the wireless tag 300 via the ambient IoT antenna 141 under control of the controller 130. The reader/writer 140 can communicate with the wireless tag 300 in a non-contact manner by using an electromagnetic field method, but in the first embodiment, the reader/writer 140 will be described as communicating with the wireless tag 300 by using a radio wave method. The reader/writer 140 can write data to or read data from the wireless tag 300.

The UE 100 is capable of wireless communication with the wireless tag 300 via the reader/writer 140. Note that the reader/writer 140 may have only a reader function without a writer function. Alternatively, the reader/writer 140 may have only the writer function without the reader function. The reader/writer 140 may be omitted. When the reader/writer 140 is not provided, the wireless communication may be performed, instead of the reader/writer 140, by the transmitter 120 or the receiver 110.

The reader/writer 140 can also perform wireless communication with the wireless tag 300 using backscattering (or backward scattering). In this case, an antenna capable of transmitting and receiving a frequency signal used in the backscattering may be included in the reader/writer 140. Note that backscattering is described in detail later.

### Configuration Example of gNB

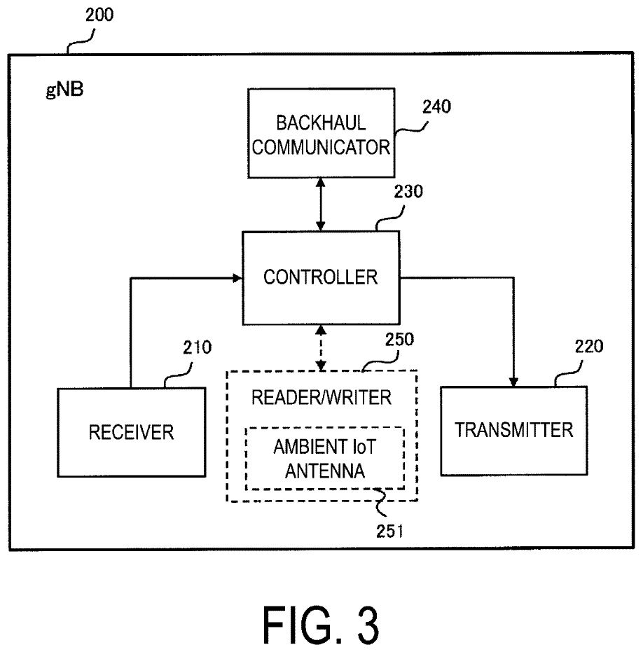

FIG. 3 is a diagram illustrating a configuration example of the gNB 200 (base station) according to the first embodiment. The gNB 200 includes a transmitter 220, a receiver 210, a controller 230, and a backhaul communicator 240. The gNB 200 may include a reader/writer 250. The transmitter 220 and the receiver 210 constitute a wireless communicator that performs wireless communication with the UE 100. The backhaul communicator 240 constitutes a network communicator that performs communication with the CN 20.

The transmitter 220 performs various types of transmission under control of the controller 230. The transmitter 220 includes an antenna and a transmission device. The transmission device converts a baseband signal (a transmission signal) output by the controller 230 into a radio signal and transmits the resulting signal through the antenna.

The receiver 210 performs various types of reception under control of the controller 230. The receiver 210 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. In an example described below, operations or processing in the gNB 200 may be performed by the controller 230.

The backhaul communicator 240 is connected to a neighboring base station via the Xn interface which is an inter-base station interface. The backhaul communicator 240 is connected to the AMF 30/UPF via the NG interface between the base station and the core network. Note that the gNB 200 may include a Central Unit (CU) and a Distributed Unit (DU) (i.e., functions are divided), and both units may be connected via an F1 interface that is a fronthaul interface.

The reader/writer 250 includes an ambient IoT antenna 251. The reader/writer 250 communicates with the wireless tag 300 via the ambient IoT antenna 251 under control of the controller 230. The reader/writer 250 can communicate with the wireless tag 300 in a non-contact manner by using an electromagnetic field method, but in the first embodiment, the reader/writer 250 will be described as communicating with the wireless tag 300 by using a radio wave method. The reader/writer 250 can write data to or read data from the wireless tag 300. The gNB 200 is capable of wireless communication with the wireless tag 300 via the reader/writer 250. Note that the reader/writer 250 may have only the reader function without the writer function. Alternatively, the reader/writer 250 may have only the writer function without the reader function. The reader/writer 250may be omitted. When the reader/writer 250is not provided, the wireless communication may be performed, instead of the reader/writer 250, by the transmitter 220or the receiver 210.

The reader/writer 250 can also perform wireless communication with the wireless tag 300 by using backscattering. In this case, an antenna capable of transmitting and receiving a frequency signal used in the backscattering may be included in the reader/writer 250.

### Configuration Example of Wireless Tag

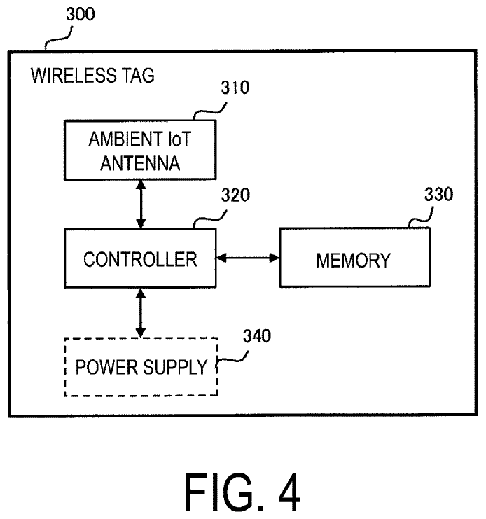

FIG. 4 is a diagram illustrating a configuration example of the wireless tag 300 according to the first embodiment. The wireless tag 300 includes an ambient IoT antenna 310, a controller 320, and a memory 330. The wireless tag 300 may include a power supply 340.

The ambient IoT antenna 310 performs wireless communication with the UE 100 or the gNB 200 by using a Radio Frequency identifier (RFID) technology. As described above, the RFID technology includes a radio wave method and an electromagnetic field method.

The radio wave method is a type of transmitting energy and signals using radio waves. In this case, the ambient IoT antenna 310 receives a radio wave transmitted from the UE 100 or the gNB 200, and a rectifier circuit provided in the ambient IoT antenna 310 outputs part of the radio wave to the controller 320 as a DC power supply. This causes the controller 320 to operate. The wireless tag 300 may perform data transmission, for example, as follows. That is, for the ambient IoT antenna 310, the controller 320 controls the reflectance of the reflected wave of a transmission wave from the UE 100 or the gNB 200. The ambient IoT antenna 310 may modulate the reflected wave by changing the reflectance of the reflected wave in accordance with the reflectance, and perform data transmission. As described above, the ambient IoT antenna 310 transmits the radio signal by using the reflected wave of an unmodulated transmission wave transmitted from the UE 100 or the gNB 200. In the UE 100 or the gNB 200, by demodulating the modulated signal included in the reflected wave, the data transmitted from the wireless tag 300 can be obtained. Communication by using a reflected wave in this manner is referred to as backscattering communication, for example. Note that the ambient IoT antenna 310 may convert a transmission signal received from the controller 320 into a radio signal of a radio band by a modulation circuit or the like provided in the ambient IoT antenna 310, and transmit the radio signal to the UE 100 or the gNB 200.

The controller 320 receives a reception signal from the ambient IoT antenna 310. For example, the controller 320 writes data included in the reception signal to the memory 330 in accordance with indication information included in the reception signal. The controller 320 reads data from the memory 330 in accordance with the indication information included in the reception signal, for example. The controller 320 outputs a transmission signal including the data that is read to the ambient IoT antenna 310. In the example described below, operations or processing in the wireless tag 300 may be performed by the controller 320.

The memory 330 stores an identifier of the wireless tag 300 (or identification information of the wireless tag 300. Hereinafter, the “identifier” and the “identification information” are not distinguished from each other in some cases), data, and the like. The memory 330 of the wireless tag 300 may adopt the Electronic Product Code (EPC) Class 1Generation 2 (GEN2) standard conforming to ISO/IEC 18000-63. The memory 330 of the EPC GEN2 standard has four memory areas of a USER memory, a Tag ID (TID) memory, an EPC memory, and a RESERVED memory. The USER memory is an area that can be freely written to and read from by a user using the wireless tag 300. The TID memory is an area that a manufacturer, model information, and the like of the wireless tag 300 are written. The TID memory is a readable and non-writable area. The EPC memory is an area that the identifier of the wireless tag 300 is written. The RESERVED memory is an area that password information of the wireless tag 300 is written. The password information includes password information used to lock writing to the wireless tag 300 and password information used to Kill the wireless tag 300.

The power supply 340 is, for example, a power supply using energy harvesting. An environment for harvesting includes heat, vibration, motion, light, wind, radio wave, or biotechnology. The energy harvesting is a power generation method in which an electromotive force is obtained from the surrounding environment as described above. The energy harvesting is different from a power generation method using a battery such as a secondary battery. However, the wireless tag 300 may be equipped with a battery to generate power by itself like an active tag. For this reason, the power supply 340 may be a battery power supply.

Note that the wireless tag 300 may have only the reader function of reading data or the like from the memory 330 without the writer function of writing data or the like to the memory 330.

The wireless tag 300 can also perform wireless communication with the UE 100 or the gNB 200 using a communication protocol in accordance with the 3GPP. In this case, instead of the ambient IoT antenna 310, an antenna capable of transmitting and receiving a radio signal having a frequency used for the 3GPP may be included in the wireless tag 300.

Hereinafter, transmission of an unmodulated transmission wave from a communication node to the wireless tag 300 may be referred to as “CW transmission”. Further, hereinafter, the reception of a reflected wave from a wireless tag in response to the transmission wave by the communication node may be referred to as “BS reception”.

### Protocol Stack

A configuration example of the protocol stack is described. Here, a configuration example of the protocol stack in the UE 100, the gNB 200, and the AMF 30 other than the wireless tag 300 is described.

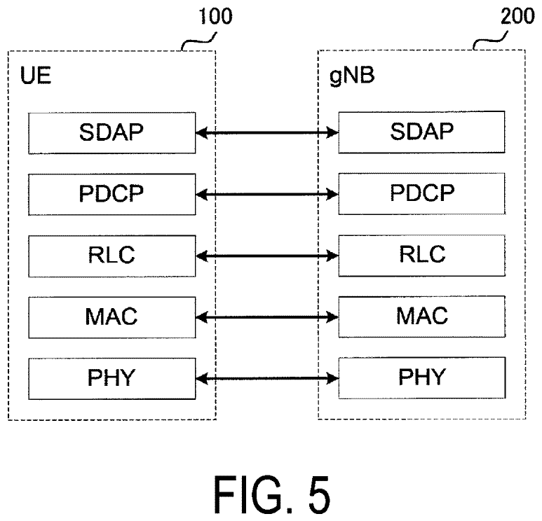

FIG. 5 is a diagram illustrating a configuration example of a protocol stack of a radio interface of a user plane handling data.

A radio interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. A Cyclic Redundancy Code (CRC) parity bit scrambled by the RNTI is added to the DCI transmitted from the gNB 200.

The MAC layer performs priority control of data, retransmission processing through hybrid ARQ (Hybrid Automatic Repeat reQuest (HARQ)), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception end by using functions of the MAC layer and the PHY layer. Data and control information are transmitted between the RLC layer of the UE 100 and the RLC layer of the gNB 200 via a logical channel.

The PDCP layer performs header compression and decompression, encryption and decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

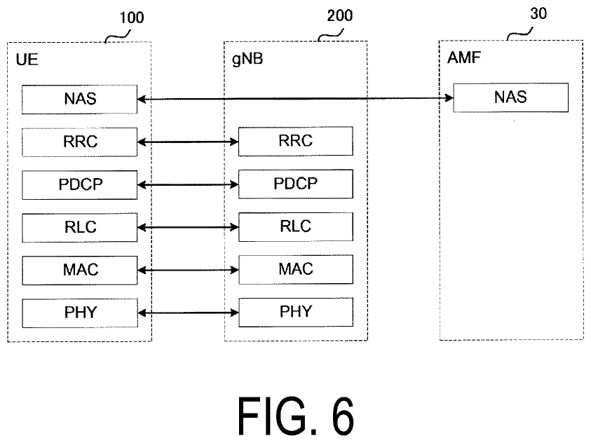

FIG. 6 is a diagram illustrating a configuration example of a protocol stack of a radio interface of a control plane handling signaling (a control signal).

The protocol stack of the radio interface of the control plane includes a Radio Resource Control (RRC) layer and a Non-Access Stratum (NAS) instead of the SDAP layer illustrated in FIG. 5.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is located above the RRC layer, performs session management, mobility management, and the like. NAS signaling is transmitted between the NAS of the UE 100 and the NAS of the AMF 30. Note that the UE 100 includes an application layer other than the protocol of the radio interface. A layer lower than the NAS is referred to as an Access Stratum (AS).

### Ambient IoT

The ambient IoT is, for example, a device with low power consumption and low complexity. The ambient IoT supports communication with a reader by reflection or transmission, and can support with very low complexity hardware. The ambient IoT can collect energy from the environment, such as an RF signal, solar energy, vibration, or heat. The ambient IOT can be equipped with a small capacity battery. The ambient IoT is also a technology capable of further reduction of a cost as compared with existing cellular IoT such as NB-IOT, LTE-M, and RedCap.

An ambient IoT device to support the ambient IoT may be a very simple device that purely has no energy storage capability (i.e., a passive device). Alternatively, the ambient IoT device may be a device that has limited energy storage capability without necessity to be manually replaced or charged. Alternatively, the ambient IoT device may be an active device that has energy storage capability. In a case of a passive device, the ambient IoT device can obtain energy from an external source and communicate by using backscattering communication.

### Agreements on Ambient IoT Device

Next, agreements on the ambient IoT device in the 3GPP will be described.

### (1.1) Ambient IoT Device Type

In the 3GPP, there are agreements on types of an ambient IoT device.

First, an ambient IoT device does not have a power supply and does not independently generate a signal. Such ambient IoT device is referred to as a “device A”. The device A can transmit a signal by backscattering. That is, the device A is a device capable of supplying power with energy harvesting, and functions as a passive device.

Second, the ambient IoT device has a small capacity power supply such as a capacitor and does not independently generate a signal. Such ambient IoT device is referred to as a “device B”. The device B can not only transmit a signal by backscattering but also amplify the signal during the backscattering.

Third, an ambient IoT device has a power supply and independently generates a signal. Such ambient IoT device is referred to as a “device C”. The device C can transmit a waveform that is normally generated by using an active component for transfer.

Hereinafter, the ambient IoT device may be referred to as the wireless tag 300.

### (1.2) Connection Form (Topology) of Ambient IoT Device

Also, in the 3GPP, there are agreements on connection forms (that is, topology) for an ambient IoT device.

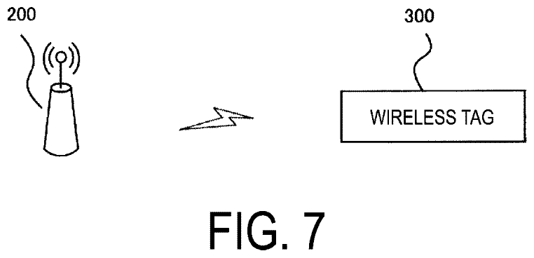

First, there is a topology (topology (1)) in which the gNB 200 and the wireless tag 300 directly communicate with each other. FIG. 7 is a diagram illustrating a link configuration example of a first topology (topology (1)) according to the first embodiment. Note that, in the example of FIG. 7, the first topology illustrating an example, in which the same gNB 200 communicates with the wireless tag 300, may include a case that a gNB 200-1 on a transmission side and a gNB 200-2 on a reception side are different from each other. That is, there is a case that transmission to and reception from the wireless tag 300 are performed by different gNBs 200.

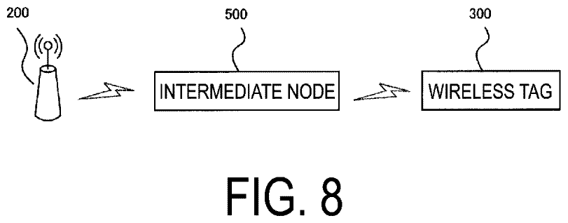

Second, there is a topology (topology (2)) in which the gNB 200 and the wireless tag 300 communicate with each other via an intermediate node 500. FIG. 8 is a diagram illustrating a link configuration example of a second topology (topology (2)) according to the first embodiment. Note that the intermediate node 500 may be a relay node. The relay node is, for example, a relay base station that is interposed between the UE 100 and the gNB 200 and relays communication between the UE 100 and the gNB 200. Alternatively, the intermediate node 500 may be an IAB node. The IAB node is, for example, a communication node that communicates with the UE 100 via an access communication link, and communicates with the gNB 200 (or a donor node) or another IAB node via a wireless backhaul communication link. Alternatively, the intermediate node 500 may be a repeater. The repeater is an example of a relay node that relays a radio signal between the network and the UE 100, and is an apparatus that can control the relay of a radio signal from the network. The repeater may be referred to as an NCR apparatus.

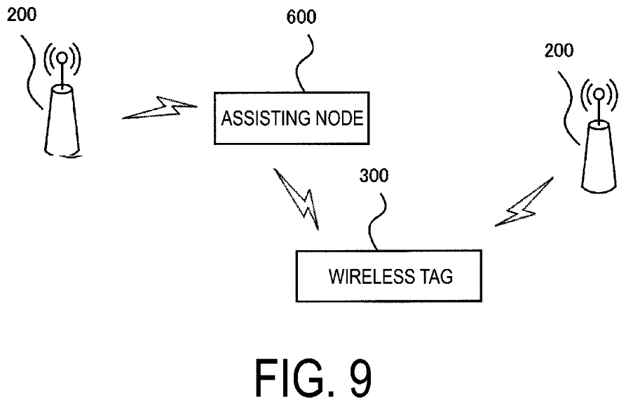

Third, there is a topology (topology (3)) in which the gNB 200 and the wireless tag 300 communicate with each other via an assisting node. FIG. 9 is a diagram illustrating a link configuration example of a third topology (topology (3)) according to the first embodiment. As illustrated in FIG. 9, there is a case that the transmission source of the wireless tag 300 is the assisting node 600 and the reception destination of the wireless tag 300 is the gNB 200. Further, there is a case that the transmission source of the wireless tag 300 is the gNB 200 and the reception destination of the wireless tag 300 is the assisting node 600. As described above, the assisting node 600 assists either the CW transmission to or the BS reception from the wireless tag 300, thereby performing communication with the wireless tag 300. Note that the assisting node 600 may be any of the IAB node, the UE 100, or a repeater node. Although the example of FIG. 9 illustrates an example in which the gNB 200 that directly communicates with the assisting node 600 and the gNB 200 that directly communicates with the wireless tag 300 are different gNBs 200, the gNB 200 that directly communicates with the assisting node 600 and the gNB 200 that directly communicates with the wireless tag 300 may be the same gNB 200.

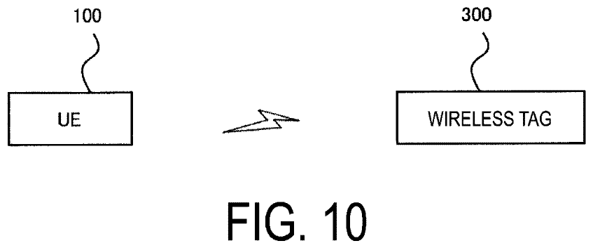

Fourth, there is a topology (topology (4)) in which the UE 100 directly communicates with the wireless tag 300. FIG. 10 is a diagram illustrating a link configuration example of a fourth topology (topology (4)) according to the first embodiment. Note that the example of FIG. 10 illustrates an example in which the same UE 100 communicates with the wireless tag 300. The fourth topology includes a case that the UE 100 on the transmission side and the UE 100 on the reception side are different from each other. That is, there is a case that transmission to and reception from the wireless tag 300 are performed by the different UEs 100.

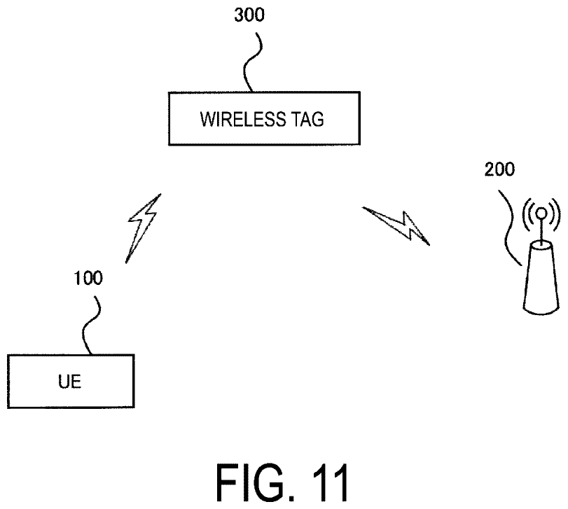

Fifth, there is a topology (topology (5)) in which the UE 100 and the gNB 200 are connected via the wireless tag 300. FIG. 11 is a diagram illustrating a link configuration example of a fifth topology (topology (5)) according to the first embodiment. As illustrated in FIG. 11, in the fifth topology, the transmission source node and the reception destination node of the wireless tag 300 are different from each other. That is, there is a case that the transmission source of the wireless tag 300 is the UE 100 and the reception destination is the gNB 200. Further, there is a case that the transmission source of the wireless tag 300 is the gNB 200 and the reception destination is the UE 100.

In the above, pieces of the topology have been described. In any topology, the communication direction may be unidirectional. The communication direction may be bidirectional.

### Problem of Ambient IoT

As described above, for the topology of the ambient IoT device, the first topology, the second topology, the third topology, the fourth topology, and the fifth topology are agreements. However, the topology configured based on the above agreements has the following problem.

For example, in the third topology (FIG. 9), a radio resource used in the communication between the assisting node 600 and the wireless tag 300 may also be used in the communication between the gNB 200-1 and the wireless tag 300. Thus, interference may occur between the communication between assisting node 600 and the wireless tag 300 and the communication between the gNB 200-1 and the wireless tag 300. When such interference occurs, the assisting node 600 may fail to appropriately communicate with the wireless tag 300 and the gNB 200-1 may also fail to appropriately communicate with the wireless tag 300. For example, when the CW transmission from the gNB 200-1 to the wireless tag 300 is performed at the time of the CW transmission from the assisting node 600 to the wireless tag 300, interference may occur between a signal of the CW transmission from the assisting node 600 to the wireless tag 300 and a signal of the CW transmission from the gNB 200-1 to the wireless tag 300. In this case, there is a problem that the assisting node 600 may become unable to perform the BS reception from the wireless tag 300, and the gNB 200-1 may also become unable to perform the BS reception from the wireless tag 300. Further, there is a case that the gNB 200 communicates with another UE 100 (FIG. 1). In this case, there is a possibility that interference occurs between the communication between the UE 100 and the gNB 200 and the communication between the ambient IoT and the gNB 200. In this case, there is a problem that the communication between the UE 100 and the gNB 200 may become impossible and the communication between the ambient IoT and the gNB 200 may become impossible. To begin with, the assisting node 600 does not know which resource is to be used for the CW transmission and/or which resource is to be used for the BS reception. Thus, there is also a problem that the resource used by the assisting node 600 needs to be configured from the gNB 200.

In the first embodiment, therefore, further included is a step of transmitting to the communication node, by the gNB 200-1, a radio resource used for the Carrier Wave or Continuous Wave (CW) transmission of a signal to the wireless tag 300 and/or a radio resource used for the BS reception.

With such a feature, the radio resource used for the CW transmission and/or the radio resource used for the BS reception are configured for the communication node. That is, the gNB 200-1 performs configuration (request) relating to the ambient IoT communication for the UE 100 and/or the neighboring gNB 200-2.

The configuration (request) relating to the ambient IoT communication is transmitted being included in a configuration message. The configuration message to the UE 100 may be transmitted as an RRC reconfiguration (RRCReconfiguration) message. The configuration message to the UE 100 may be transmitted as an SI message including SIB. On the other hand, the configuration message to the neighboring gNB 200-2 may be transmitted as an Xn message. The configuration message for the neighboring gNB 200-2 may be transmitted as a new ambient IoT communication request or the like.

The configuration (request) relating to the ambient IoT communication includes at least any of the following contents as a notification content.

First, the configuration (request) relating to the ambient IoT communication includes information relating to the CW transmission. The information relating to the CW transmission includes at least one selected from the group consisting of time information, frequency information, and transmission power information. The time information relating to the CW transmission may be represented by a Hyper Frame Number (HFN), a radio frame, a subframe, a slot, or the like. The time information relating to the CW transmission may include information indicating a repeated transmission pattern. The repeated transmission pattern is, for example, transmission once in several slots, or the like. For example, the information indicating the repeated transmission pattern may be configured by a bitmap. Specifically, each bit may correspond to a time unit (for example, a slot), and “0” may indicate that use is not allowed and “1” may indicate that use is allowed. Note that “0” may indicate that use is allowed, and “1” may indicate that use is not allowed.

The frequency information relating to the CW transmission may be represented by a center frequency of the frequency used for the CW transmission. Alternatively, the frequency information relating to the CW transmission may be represented by a resource block (Physical Resource Block (PRB)), a resource element (RE), or a subcarrier number used for the CW transmission. Note that the resource block is a collection of 12 subcarriers on a frequency axis. The resource element corresponds to one subcarrier (frequency axis). A cell ID is information for specifying the position of a communication node. The information of the cell ID may, for example, be indicated by a frequency.

The transmission power information relating to the CW transmission may include a transmission power value used for the CW transmission. By taking the transmission power value of the CW transmission signal into account, communication may be performed with mitigated interference between cells managed by the gNB 200. Note that the transmission power information relating to the CW transmission may include an array antenna weight (precoding matrix) used for the CW transmission. By taking a transmission antenna weight value of the CW transmission signal into account, beam formation may be performed toward the specific wireless tag 300 (or the area where the specific wireless tag 300 is present).

Second, the configuration (request) relating to the ambient IoT communication includes information relating to the BS reception. The information relating to the BS reception includes at least one selected from the group consisting of time information, frequency information, and tag identifier information. The time information relating to the BS reception may include information indicating a time length of a radio frame and/or a time length of a slot. The time information may include information indicating a repeated reception pattern and/or a configuration of the number of times of the BS reception. For example, when it is assumed that the CW transmission is performed several times to cause the BS reception, the BS reception destination can improve Signal to Noise Ratio (SNR) by performing combining reception of signals received in the repeated reception pattern.

The frequency information relating to the BS reception may include information indicating a center frequency of a signal of the BS reception. The frequency information may include information indicating at least one selected from the group consisting of a signal bandwidth, a channel, a cell ID, a resource block (RB) number, and a subcarrier number of the BS reception. Note that the frequency information relating to the BS reception may be frequency configuration information of the CW transmission. That is, the frequency configuration information of the BS reception may be derived based on the specifications of the gNB 200 and the frequency configuration information of the CW transmission.

The tag identifier information relating to the BS reception may be a list of tag IDs expected to be received. Note that when the gNB 200 receives a tag ID different from the tag ID expected to be received in the BS reception, the gNB 200 may discard the identifier information as the BS reception information indicating the different tag ID. That is, the BS reception information from the tag ID that matches the tag ID expected to be received may be reported to the gNB.

Note that the information relating to the BS reception may include an array antenna weight (precoding matrix) used for the BS reception. By taking a reception antenna weight value of the BS reception into account, the reception beam formation may be performed toward the specific wireless tag 300 (or the area where the specific wireless tag 300 is present).

The UE 100 or the neighboring gNB 200-2 communicates with the ambient IoT device in accordance with the configuration relating to the ambient IoT communication. For example, when the CW transmission is configured, the UE 100 or the neighboring gNB 200-2 may perform the CW transmission at the configured time and frequency. Further, for example, when the BS reception is configured, the UE 100 or the neighboring gNB 200-2 may perform the BS reception at the configured time and frequency.

The UE 100 or the neighboring gNB 200-2 for which the BS reception is configured reports a reception result to the gNB 200-1. For example, the UE 100 or the neighboring gNB 200-2 for which the BS reception is configured may report the tag identifier information received with the BS reception to the gNB 200-1 as a reception result. Alternatively, the UE 100 or the neighboring gNB 200-2 for which the BS reception is configured may report the time information and/or the frequency information (of each tag) received with the BS reception in addition to the tag identifier information.

With the configuration above, the radio resource used when a communication node communicates with the wireless tag 300 is not used for another communication. Thus, it becomes possible to avoid the occurrence of interference.

In the first embodiment, an example will be described in which the assisting node is the communication node in the link configuration based on the third topology (FIG. 9). An example of the assisting node is the UE 100, but may be the neighboring gNB 200-2.

### Communication Control Method According to First Embodiment

A communication control method according to the first embodiment will be described.

### Operation Example According to First Embodiment

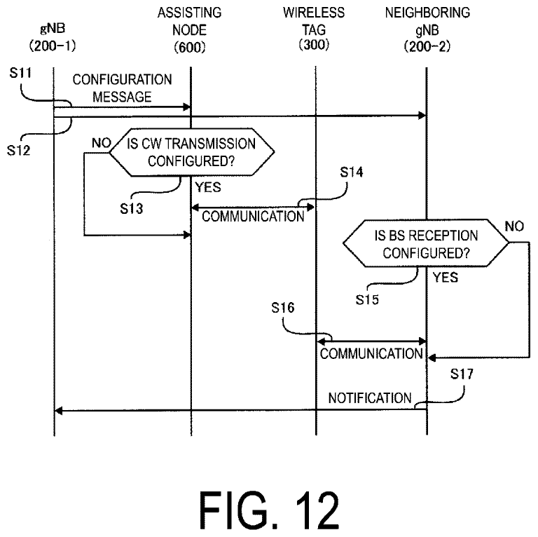

FIG. 12 is a diagram illustrating a first operation example according to the first embodiment. Note that, in the operation example of FIG. 12, an example will be described in which the assisting node 600 as the communication node is the UE 100. Specifically, in FIG. 12, an example will be described in which the assisting node 600 (the UE 100) performs the CW transmission and the neighboring gNB 200-2 performs the BS reception. Note that the gNB 200-1 may perform the BS reception instead of the neighboring gNB 200-2. Further, the neighboring gNB 200-2 may perform the CW transmission, and the assisting node 600 (the UE 100) may perform the BS reception. Here, the assisting node 600 (the UE 100) is RRC connected to the gNB 200-1 and is in the RRC connected state.

In step S11, the gNB 200-1 transmits a configuration message to the assisting node 600 (the UE 100). This enables the gNB 200-1 to perform configuration (request) relating to the ambient IoT for the assisting node 600 (the UE 100). For example, as the configuration relating to the ambient IoT, information relating to the CW transmission is transmitted to the assisting node 600 (the UE 100) as the configuration message. As described above, the configuration message is transmitted as the RRC reconfiguration (RRCReconfiguration) message. Note that, prior to step S11, a message requesting the ambient IoT configuration may be transmitted from the assisting node 600 (the UE 100) to the gNB 200-1. The request message may include the information relating to the CW transmission or the information relating to the BS reception as a desired configuration content (or configuration assistance information). Such request message will be described in a third embodiment.

In step S12, the gNB 200-1 transmits the configuration message to the neighboring gNB 200-2. This enables the gNB 200-1 to perform configuration (request) relating to the ambient IoT for the neighboring gNB 200-2. For example, as the configuration relating to the ambient IoT, the configuration message relating to the BS reception is transmitted to the neighboring gNB 200-2. As described above, the configuration message is transmitted as the Xn message. Note that, prior to step S12, a message requesting the ambient IoT configuration may be transmitted from the neighboring gNB 200-2 to the gNB 200-1. The request message may include the information relating to the CW transmission or the information relating to the BS reception as the desired configuration content. Such request message will be described in the third embodiment.

In step S13, when the CW transmission is configured, the assisting node 600 (the UE 100) communicates with the wireless tag 300 in step S14 in accordance with the configuration of the CW transmission. Specifically, the assisting node 600 (the UE 100) performs the CW transmission based on the information relating to the CW transmission included in the configuration message. Note that, when the BS reception is configured instead of the CW transmission as the configuration message to the assisting node 600 (the UE 100), the assisting node 600 (the UE 100) performs the BS reception.

In step S15, when the BS reception is configured, the neighboring gNB 200-2 performs communication with the wireless tag 300 in accordance with the configuration of the BS reception in step S16. Specifically, the neighboring gNB 200-2 performs the BS reception based on the information relating to the BS reception included in the configuration message. Note that when the CW transmission is configured instead of the BS reception as the configuration message to the neighboring gNB 200-2, the neighboring gNB 200-2 performs the CW transmission.

In step S17, the neighboring gNB 200-2 notifies the gNB 200-1 of data received in communication with the wireless tag 300, for example, the identifier information. The identifier information is information indicating the identifier for identifying the wireless tag 300 having performed the BS reception. In addition to the identifier information, the UE 100 may notify time information and/or frequency information for each wireless tag 300 having performed the BS reception. Alternatively, the neighboring gNB 200-2 notifies the gNB 200-1 of the identifier information. The identifier information is information indicating the identifier for identifying the wireless tag 300 having performed the BS reception. In addition to the identifier information, the neighboring gNB 200-2 may notify time information and/or frequency information for each wireless tag 300 having performed the BS reception.

### Variation 1 of First Embodiment

In the first embodiment, an example has been described in which the assisting node 600 as the communication node is the UE 100, but the assisting node 600 is not limited to the UE 100.

The assisting node 600 as the communication node may be an IAB-MT instead of the UE 100. The IAB-MT is a functional block of a portion having a terminal function in the IAB node. The IAB-MT has a function the same and/or similar to that of the UE 100. In this case, the gNB 200-1 notifies the IAB-MT of the CW transmission resource. The BS reception information may be reported, with the IAB-MT in the RRC connected state with the gNB 200-1 transmitting an RRC message including the identifier information to the CU of the gNB 200-1 (i.e., the IAB-donor-CU).

### Variation 2 of First Embodiment

The assisting node 600 as the communication node may be a Network-controlled Repeater-Mobile Terminal (NCR-MT) included in the NCR apparatus instead of the UE 100. The NCR apparatus is an example of a relay node that relays a radio signal, and is also an example of a repeater apparatus that can be controlled from the network. The NCR-MT is a block that is included in the NCR apparatus, establishes a wireless connection with the gNB 200-1, and functions as a control terminal that controls the relay of the NCR apparatus together with the gNB 200-1. The NCR-MT has a function the same and/or similar to that of the UE 100.

### Variation 3 of First Embodiment

The assisting node 600 as the communication node may be the relay node instead of the UE 100. The gNB 200-1 may transmit the information relating to the CW transmission and/or the information relating to the BS reception to the relay node by using the Xn message.

### Second Embodiment

Next, a communication control method according to a second embodiment will be described.

As described above, in the topology configured based on the above agreements, interference of radio resources may occur.

For example, the radio resource used between the distributed unit in the gNB 200 and the wireless tag 300 may also be used for communication between the distributed unit in the gNB 200 and the UE 100. Thus, interference may occur between the communication between the distributed unit in the gNB 200 and the wireless tag 300 and the communication between the distributed unit in the gNB 200 and the UE 100. When such interference occurs, the distributed unit in the gNB 200 may fail to appropriately perform communication with the wireless tag 300 and may also fail to appropriately perform communication with the UE 100. Thus, there is a problem that, between the distributed unit in the gNB 200 and the wireless tag 300, the CW transmission and/or the BS reception may become impossible to perform.

In the second embodiment, therefore, the communication node is the distributed unit in the gNB 200, and further included is a step of transmitting to the distributed unit in the gNB 200, by the central unit in gNB 200, a radio resource used for the CW transmission of a signal to the wireless tag 300 and/or a radio resource used for the BS reception of a signal reflected from the wireless tag 300.

With such a feature, in the distributed unit in the gNB 200, a radio resource used for the CW transmission and/or a radio resource used for the BS reception is reserved. This enables the distributed unit in the gNB 200 to perform the CW transmission and/or the BS reception by using the reserved radio resource. Thus, it becomes possible to avoid that the CW transmission and/or the BS reception cannot be performed between the distributed unit in the gNB 200 and the wireless tag 300.

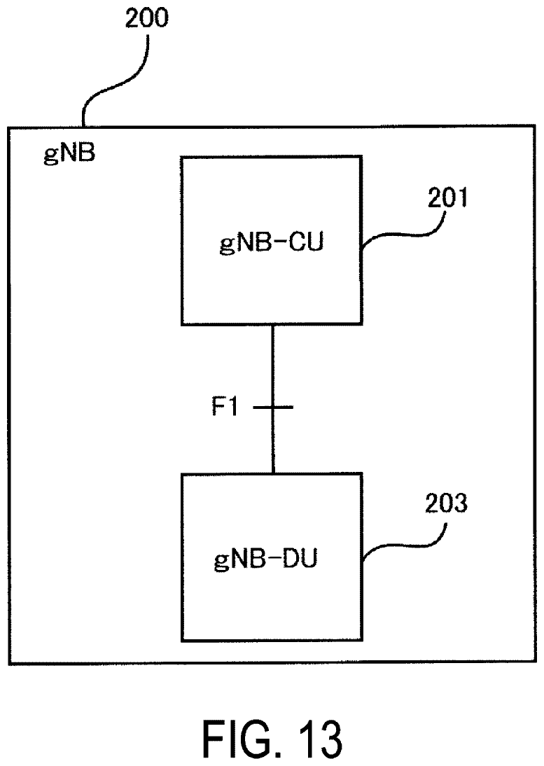

FIG. 13 is a diagram illustrating a configuration example of the gNB 200 according to the second embodiment. The gNB 200 may be constituted of a gNB-CU 201 and a gNB-DU 203. The gNB-CU 201 and the gNB-DU 203 are connected via an F1 interface. One gNB-DU 203 is connected to only one gNB-CU 201.

The gNB-CU 201 serves as a central unit of the gNB 200. The gNB-CU 201 is a logical node hosting the protocols of the RRC, the SDAP, and the PDCP in the gNB 200. The gNB-CU 201 functions as a main entity of control of the gNB-DU 203. The gNB-DU 203 functions as a distributed unit in the gNB 200. The gNB-DU 203 is a logical node hosting the layers of the RLC, the MAC and the PHY of the gNB 200.

When the gNB-CU 201 is the main entity of control, the gNB-DU 203 actually performs the CW transmission/BS reception. Thus, the gNB-CU 201 configures the CW transmission/BS reception for the gNB-DU 203 via the F1 interface.

### Operation Example According to Second Embodiment

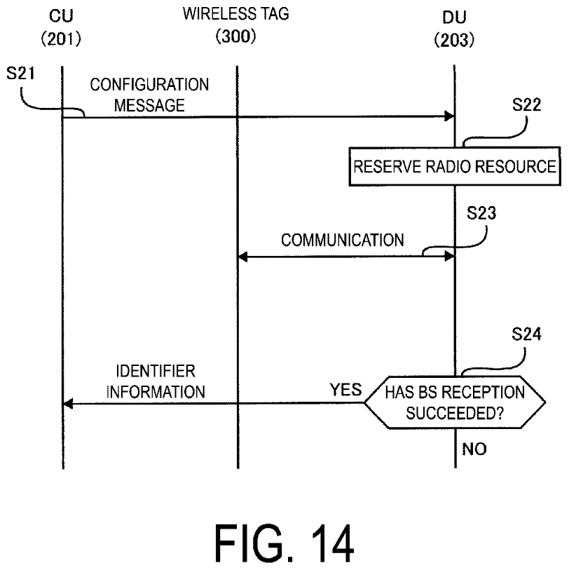

FIG. 14 is a diagram illustrating an operation example according to the second embodiment.

In step S21, the gNB-CU 201 transmits a configuration message to the gNB-DU 203. This enables the gNB-CU 201 to perform configuration (request) relating to the ambient IoT for the gNB-DU 203. For example, as the configuration relating to the ambient IoT, information relating to the CW transmission is transmitted to the gNB-DU 203 as the configuration message. The configuration message is transmitted as an F1 message. Alternatively, information relating to the BS reception may be transmitted to the gNB-DU 203 as the configuration message, instead of the information relating to the CW transmission. Alternatively, in addition to the information relating to the CW transmission, the information relating to the BS reception may also be transmitted as the configuration message. Note that the information relating to the CW transmission or the information relating to the BS reception included in the configuration message in step S21 is the same and/or similar to the information relating to the CW transmission or the information relating to the BS reception included in the configuration message in step S11 of the first embodiment.

In step S22, the gNB-DU 203 reserves a radio resource. Here, when the step S21 configuration message includes the information relating to the CW transmission, a radio resource used for the CW transmission is reserved. Further, when the step S21 configuration message includes the information relating to the BS reception, a radio resource used for the BS reception is reserved.

In step S23, gNB-DU 203 communicates with the wireless tag 300 with the reserved radio resource. Specifically, when the configuration message includes the information relating to the CW transmission, the gNB-DU 203 performs the CW transmission. Note that, when the configuration message includes the information relating to the BS reception, the gNB-DU 203 performs the BS reception.

In step S24, when the BS reception succeeds, the gNB-DU 203 communicates the received identifier information to the gNB-CU 201.

In step S24, the gNB-DU 203 notifies the gNB-CU 201 of the identifier information. The identifier information is information indicating the identifier for identifying the wireless tag 300 having performed the BS reception.

### Third Embodiment

Next, a communication control method according to a third embodiment will be described.

As described above, in the topology configured based on the above agreements, interference of radio resources may occur.

For example, in the fifth topology (FIG. 11), the radio resource used in the communication between the UE 100 and the wireless tag 300 may also be used in the communication between the gNB 200 and the wireless tag 300. Thus, interference may occur between the communication between the UE 100 and the wireless tag 300 and the communication between the gNB 200 and the wireless tag 300. When such interference occurs, the UE 100 may fail to appropriately communicate with the wireless tag 300 and the gNB 200 may also fail to appropriately communicate with the wireless tag 300. For example, when the CW transmission from the gNB 200 to the wireless tag 300 is performed at the time of the CW transmission from the UE 100 to the wireless tag 300, interference may occur between a signal of the CW transmission from the UE 100 to the wireless tag 300 and a signal of the CW transmission from the gNB 200 to the wireless tag 300. In this case, there is a problem that the UE 100 may become unable to perform the BS reception from the wireless tag 300, and the gNB 200 also may become unable to perform the BS reception from the wireless tag 300.

In the third embodiment, therefore, a communication control method in a wireless communication system includes a step of requesting, by a communication node, the gNB 200 to perform the backscattering (BS) reception of a signal reflected from the wireless tag 300.

With such a feature, the gNB 200 is ready to cooperate with the BS reception. This makes it possible to avoid conflict between the radio resource used by the gNB 200 and the radio resource used by the UE 100. Thus, it becomes possible to avoid the occurrence of interference.

In the third embodiment, an example will be described in which the UE 100 is the communication node in the link configuration based on the fifth topology (FIG. 11).

### Operation Example According to Third Embodiment

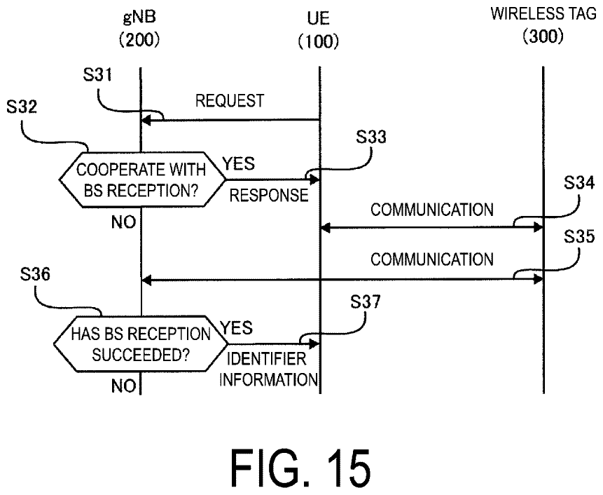

FIG. 15 is a diagram illustrating an operation example according to the third embodiment. In the operation example of FIG. 15, an example will be described in which the UE 100 is the communication node. The UE 100 is RRC connected with the gNB 200 and is in the RRC connected state.

In step S31, the UE 100 requests the gNB 200 for the CW transmission and/or the BS reception. Specifically, the UE 100 transmits a message including a request for the CW transmission and/or the BS reception to the gNB 200. The message may be an RRC message such as a UE Assistance Information message or the like. The message may be another RRC message. The message may be an ambient IoT request as a new message in a layer newly provided for the ambient IoT. The message may be a MAC Control Element (MAC CE) instead of the RRC message.

The request includes at least any of the following contents.

First, the information relates to the CW transmission. The information relating to the CW transmission includes at least one selected from the group consisting of time information, frequency information, and transmission power information. The time information, the frequency information, and the transmission power information are respectively the same and/or similar to the time information, the frequency information, and the transmission power information in the first embodiment.

Second, the information relates to the BS reception. The information relating to the BS reception includes at least one selected from the group consisting of time information, frequency information, and tag identifier information. The time information, the frequency information, and the tag identifier information are respectively the same and/or similar to the time information, the frequency information, and the tag identifier information in the first embodiment.

Note that the neighboring gNB 200 neighboring the gNB 200 may request the gNB 200 for the CW transmission and/or the BS reception via the Xn interface. In this case, the message including the request for the CW transmission and/or the BS reception may be transmitted as the Xn message. The message including the request for the CW transmission and/or the BS reception may be transmitted as a gNB Configuration Update message.

In step S32, when the gNB 200 cooperates with the BS reception, the gNB 200 may transmit an affirmative response to the UE 100 in step S33. Further, in step S32, when the gNB 200 cooperates with the BS reception, the gNB 200 may transmit the CW transmission and/or the BS reception to the UE 100 as the configuration message, instead of transmitting the affirmative response to the UE 100. The configuration message is described in the first embodiment (see step S11 in FIG. 12). That is, the gNB 200 can perform the BS reception and the UE 100 can perform the CW transmission. When the gNB 200 performs the CW transmission, the BS reception and/or the CW transmission may be configured for the UE 100. In step S32, when the gNB 200 does not cooperate with the BS reception, the gNB 200 need not transmit the response. Note that the gNB 200 may transmit a negative response to the UE 100 when the gNB 200 does not cooperate with the BS reception.

In step S34, the UE 100 performs the CW transmission to the wireless tag 300.

In step S35, the gNB 200 performs the BS reception from the wireless tag 300.

In step S36, when the gNB 200 succeeds in the BS reception from the wireless tag 300, the gNB 200 may transmit a message including the tag identifier as the identifier information to the UE 100 in step S37. The message may be an RRC message. The message may be another RRC message or the ambient IoT request. The message may be the MAC Control Element (MAC CE) instead of the RRC message. For example, when the BS reception from the wireless tag 300 fails, the gNB 200 need not transmit the message to the UE 100. Note that when the BS reception from the wireless tag 300 fails, the gNB 200 may transmit a message including information indicating failure, that is, information indicating that no wireless tag 300 has been detected, to the UE 100.

In the third embodiment, instead of the UE 100, the neighboring gNB 200 neighboring the gNB 200 may request the gNB 200 for the BS reception.

### Variation 1 of Third Embodiment

The communication node may be the IAB-MT instead of the UE 100. The IAB-MT is a functional block of a portion having a terminal function in the IAB node. The IAB-MT has a function the same and/or similar to that of the UE 100. In this case, the gNB 200-1 notifies the IAB-MT of information relating to the CW transmission and/or information relating to the BS reception. The BS reception information may be reported, with the IAB-MT in the RRC connected state with the gNB 200-1 transmitting an RRC message including the identifier information to the CU of the gNB 200-1 (i.e., the IAB-donor-CU).

### Variation 2 of Third Embodiment

The communication node may be a Network-controlled Repeater-Mobile Terminal (NCR-MT) included in the NCR apparatus instead of the UE 100. The NCR apparatus is an example of the relay node that relays a radio signal, and is also an example of the repeater apparatus that can be controlled from the network. The NCR-MT is a block that is included in the NCR apparatus, establishes a wireless connection with the gNB 200, and functions as a control terminal that controls the relay of the NCR apparatus together with the gNB 200. The NCR-MT has a function the same and/or similar to that of the UE 100.

### Variation 3 of Third Embodiment

The communication node may be the relay node instead of the UE 100. The gNB 200 may transmit information relating to the CW transmission and/or information relating to the BS reception to the relay node by using the Xn message.

### Fourth Embodiment

Next, a communication control method according to a fourth embodiment will be described.

As described above, in the topology configured based on the above agreements, interference of radio resources may occur.

For example, in the fifth topology (FIG. 11), the radio resource used in the communication between the gNB 200 and the wireless tag 300 may be used in the communication between the gNB 200 and the UE 100. Thus, interference may occur between the communication between the gNB 200 and the wireless tag 300 and the communication between the gNB 200 and the UE 100. When such interference occurs, the gNB 200 may fail to appropriately communicate with the wireless tag 300 and may fail to appropriately communicate with the UE 100. For example, when the transmission from the UE 100 to the gNB 200 is performed at the time of the CW transmission from the gNB 200 to the wireless tag 300, interference may occur between a signal of the CW transmission from the gNB 200 to the wireless tag 300 and a signal of the transmission from the UE 100 to the gNB 200. In this case, there is a problem that the gNB 200 may become unable to perform the BS reception from the wireless tag 300.

In the fourth embodiment, therefore, further included is a step of transmitting to the communication node, by the gNB 200-1, a transmission prohibited resource that is prohibited the Carrier Wave or Continuous Wave (CW) transmission of a signal to the wireless tag 300.

With such a feature, a transmission prohibited resource that is prohibited the CW transmission is reserved for the communication node. Thus, the communication node does not perform communication by using the transmission prohibited resource. Even when the gNB 200-1 communicates with the wireless tag 300 by using the transmission prohibited resource, since the communication node does not use the transmission prohibited resource, no interference occurs. Thus, it becomes possible to avoid the occurrence of interference.

In the fourth embodiment, an example will be described in which each of the UE 100 and the neighboring gNB 200-1 is the communication node in the link configuration based on the fifth topology (FIG. 11), but the communication node may be any of the UE 100 or the neighboring gNB 200.

### Operation Example According to Fourth Embodiment

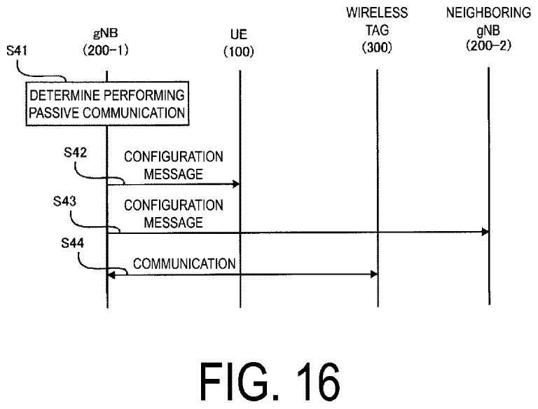

FIG. 16 is a diagram illustrating an operation example according to the fourth embodiment. Note that, in the operation example of FIG. 16, the UE 100 is RRC connected to the gNB 200 and is in the RRC connected state.

In step S41, the gNB 200-1 determines to perform passive communication.

In step S42, the gNB 200-1 transmits a configuration message to the UE 100. This enables the gNB 200-1 to perform configuration (request) relating to the transmission prohibited resource for the UE 100. The configuration message is transmitted with the RRC reconfiguration (RRCReconfiguration) message.

The configuration relating to the transmission prohibited resource includes at least any of the following contents.

First, the information relates to the CW transmission. The information relating to the CW transmission includes at least one selected from the group consisting of time information, frequency information, and transmission power information. The time information, the frequency information, and the transmission power information are respectively the same and/or similar to the time information, the frequency information, and the transmission power information in the first embodiment.

Second, the information relates to the BS reception. The information relating to the BS reception includes at least one selected from the group consisting of time information, frequency information, and tag identifier information. The time information, the frequency information, and the tag identifier information are respectively the same and/or similar to the time information, the frequency information, and the tag identifier information in the first embodiment.

When the transmission prohibited resource as described above is configured in the UE 100, the UE 100 is prohibited from using the transmission prohibited resource. Thus, even when the gNB 200-1 communicates with the wireless tag 300 by using the transmission prohibited resource, interference from the UE 100 does not occur.

In step S43, the gNB 200-1 transmits the configuration message to the neighboring gNB 200-2. This enables the gNB 200-1 to perform configuration (request) relating to the transmission prohibited resource for the neighboring gNB 200-2. The configuration message is transmitted with the Xn message.

In step S44, the gNB 200 performs communication with the wireless tag 300 by using the transmission prohibited resource.

### Variation 1 of Fourth Embodiment

The communication node may be the IAB-MT instead of the UE 100. The IAB-MT is a functional block of a portion having a terminal function in the IAB node. The IAB-MT has a function the same and/or similar to that of the UE 100. In this case, the gNB 200-1 notifies the IAB-MT of the transmission prohibited resource. The BS reception information may be reported, with the IAB-MT in the RRC connected state with the gNB 200-1 transmitting an RRC message including the identifier information to the CU of the gNB 200-1 (i.e., the IAB-donor-CU).

### Variation 2 of Fourth Embodiment

The communication node may be a Network-controlled Repeater-Mobile Terminal (NCR-MT) included in the NCR apparatus instead of the UE 100. The NCR apparatus is an example of the relay node that relays a radio signal, and is also an example of the repeater apparatus that can be controlled from the network. The NCR-MT is a block that is included in the NCR apparatus, establishes a wireless connection with the gNB 200, and functions as a control terminal that controls the relay of the NCR apparatus together with the gNB 200. The NCR-MT has a function the same and/or similar to that of the UE 100.

### Variation 3 of Fourth Embodiment

The communication node may be the relay node instead of the UE 100. The gNB 200 may transmit the transmission prohibited resource to the relay node by using the Xn message.

### Other Embodiments

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

That is, the UE 100 may be a terminal function unit (a type of communication module) for a base station to control a repeater that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each of the processes performed by the UE 100, the gNB 200, or the AMF 30 may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM.

Circuits for executing each of the processes performed by the UE 100, the gNB 200, or the AMF 30 may be integrated, and at least part of the UE 100, the gNB 200, or the AMF 30 may be configured as a semiconductor integrated circuit (a chipset or a System on a Chip (SoC)).

The functions achieved by the UE 100, the gNB 200, or the AMF 30 may be implemented in circuitry or processing circuitry including general purpose processors and special purpose processors that are programmed to achieve the described functions, integrated circuits, application specific integrated circuits (ASICs), a central processing unit (CPU), conventional circuits, and/or combinations thereof. The processor includes a transistor and other circuits, and is considered as circuitry or processing circuitry. The processor may be a programmed processor that executes a program stored in a memory. In the present description, circuitry, units, means are hardware programmed to achieve or hardware to execute the described functions. The hardware may be any hardware disclosed in the present description, any hardware programmed to achieve or known to execute the described functions. When the hardware is a processor considered to be a type of circuitry, the circuitry, means, or units are a combination of hardware and software used to configure the hardware and/or processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure. All or some of the embodiments, operations, processes, and steps may be combined without being inconsistent.

### Supplements

### Supplementary Note 1

A communication control method in a wireless communication system, the communication control method including:
requesting, by a communication node, a network node to perform backscattering (BS) reception of a signal reflected from a wireless tag,
in which the request includes information indicating at least one selected from the group consisting of resource information indicating a radio resource used for the BS reception, cell information indicating a cell operated by the network node that performs the BS reception, and identifier information indicating an identifier identifying the wireless tag.

### Supplementary Note 2

The communication control method according to Supplementary Note 1 further including the steps of:
transmitting, by the network node to the communication node, the identifier information when the BS reception succeeds; and
transmitting, by the network node to the communication node, information indicating failure when the BS reception fails.

### Supplementary Note 3

The communication control method according to Supplementary Note 1, further including:
transmitting, by the network node to the communication node or a neighboring network node neighboring the network node, a radio resource used for Carrier Wave or Continuous Wave (CW) transmission of a signal to the wireless tag and/or a radio resource used for the BS reception.

### Supplementary Note 4

The communication control method according to Supplementary Note 1, further including:
transmitting, by the network node to the communication node or a neighboring network node neighboring the network node, a transmission prohibited resource in which Carrier Wave or Continuous Wave (CW) transmission of a signal to the wireless tag is prohibited.

### Supplementary Note 5

The communication control method according to Supplementary Note 1, in which the communication node is any of a user equipment, an IAB-MT of an IAB node, a Relay-node, or a Repeater of an NCR.

### Supplementary Note 6

The communication control method according to Supplementary Note 1, in which the communication node is a distributed unit in the network node, and
the communication control method further includes transmitting, by a central unit of the network node to a distributed unit (DU) of the reference station, a radio resource used for Carrier Wave or Continuous Wave (CW) transmission of a signal to the wireless tag and/or a radio resource used for the BS reception of a signal reflected from the wireless tag.

### REFERENCE SIGNS

1: Wireless communication system
10: NG-RAN
20: 5GC (CN)
30: AMF
100: UE
110: Receiver
120: Transmitter
130: Controller
140: Reader/writer
141: Ambient IoT antenna
200: gNB
210: Receiver
220: Transmitter
230: Controller
250: Reader/writer
251: Ambient IoT antenna
300: Wireless tag
310: Ambient IoT antenna
320: Controller
330: Memory
340: Power supply
500: Intermediate node
600: Assisting node

1. A communication control method in a wireless communication system, the communication control method comprising:
requesting, by a communication node, a network node to perform backscattering (BS) reception of a signal reflected from a wireless tag,
wherein the request includes information indicating at least one selected from the group consisting of a radio resource used for the BS reception, a cell ID indicating a cell operated by the network node that performs the BS reception, and identifier information indicating an identifier identifying the wireless tag.

2. The communication control method according to claim 1 further comprising:
transmitting, by the network node to the communication node, the identifier information identifying the wireless tag when the BS reception succeeds; and
transmitting, by the network node to the communication node, information indicating failure when the BS reception fails.

3. The communication control method according to claim 1, further comprising:
transmitting, by the network node to the communication node, a radio resource used for Carrier Wave or Continuous Wave (CW) transmission of a signal to the wireless tag and/or a radio resource used for the BS reception.

4. The communication control method according to claim 1, further comprising:
transmitting, by the network node to the communication node, a transmission prohibited resource in which Carrier Wave or Continuous Wave (CW) transmission of a signal to the wireless tag is prohibited.

5. The communication control method according to claim 1, wherein
the communication node is any of a user equipment, an IAB-Mobile Terminal (MT) of an IAB node, a Relay-node, or a Network-controlled Repeater (NCR)-MT included in an NCR apparatus.

6. The communication control method according to claim 1, wherein
the communication node is a distributed unit in the network node, and
the communication control method further includes transmitting, by a central unit (CU) of the network node to a distributed unit (DU) of the network node, a radio resource used for Carrier Wave or Continuous Wave (CW) transmission of a signal to the wireless tag and/or a radio resource used for the BS reception of a signal reflected from the wireless tag.

7. A communication node used in a wireless communication system, the communication node comprising:
a transmitter configured to transmit to a network node, a message requesting to perform backscattering (BS) reception of a signal reflected from a wireless tag,
wherein the request includes information indicating at least one selected from the group consisting of a radio resource used for the BS reception, a cell ID indicating a cell operated by the network node that performs the BS reception, and identifier information indicating an identifier identifying the wireless tag.
